(19) United States
(12) Patent Application Publication
(10) Pub. No.: US 2020/0201915 A1
(43) Pub. Date: Jun. 25, 2020

(54) RANKING IMAGE SEARCH RESULTS USING MACHINE LEARNING MODELS

(71) Applicant: Google LLC, Mountain View, CA (US)

(72) Inventors: Manas Ashok Pathak, Sunnyvale, CA (US); Sundeep Tirumalareddy, Mountain View, CA (US); Wenyuan Yin, Santa Clara, CA (US); Suddha Kalyan Basu, San Jose, CA (US); Shubhang Verma, Mountain View, CA (US); Sushrut Karanjkar, Cupertino, CA (US); Thomas Richard Strohmann, Cupertino, CA (US)

(21) Appl. No.: 16/263,398

(22) Filed: Jan. 31, 2019

Related U.S. Application Data
(60) Provisional application No. 62/783,134, filed on Dec. 20, 2018.

(51) Int. Cl. G06F 16/903; G06F 16/583; G06F 16/538; G06N 3/08

(52) U.S. Cl. CPC G06F 16/90335; G06N 3/08; G06F 16/538; G06F 16/583

(57) ABSTRACT

Methods, systems, and apparatus including computer programs encoded on a computer storage medium, for ranking image search results using machine learning models. In one aspect, a method includes receiving an image search query from a user device; obtaining a plurality of candidate image search results; for each of the candidate image search results: processing (i) features of the image search query and (ii) features of the respective image identified by the candidate image search result using an image search result ranking machine learning model to generate a relevance score that measures a relevance of the candidate image search result to the image search query; ranking the candidate image search results based on the relevance scores; generating an image search results presentation; and providing the image search results for presentation by a user device.

### CROSS-REFERENCE TO RELATED APPLICATION

This application claims priority to U.S. Provisional Application No. 62/783,134, filed on Dec. 20, 2018. The disclosure of the prior application is considered part of and is incorporated by reference in the disclosure of this application.

### BACKGROUND

This specification generally relates to ranking image search results.

Online search engines generally rank resources, e.g., images, in response to received search queries to present search results identifying resources that are responsive to the search query. Search engines generally present the search results in an order that is defined by the ranking. Search engines may rank the resources based on various factors, i.e., based on various search engine ranking signals, and using various ranking techniques.

Some conventional image search engines, i.e., search engines configured to identify images on landing pages, e.g., on webpages on the Internet, in response to received search queries, generate separate signals from the i) features of the image and ii) features of the landing page and then combine the separate signals according to a fixed weighting scheme that is the same for each received search query.

### SUMMARY

This specification describes technologies for generating relevance values of image-landing page pairs and ranking the image search results based on the relevance score for the corresponding image search query.

In one aspect, receiving an image search query from a user device; obtaining a plurality of candidate image search results for the image search query, each candidate image search result identifying a respective image and a respective landing page for the respective image; for each of the candidate image search results: processing (i) features of the image search query, (ii) features of the respective image identified by the candidate image search result, and (iii) features of the respective landing page identified by the candidate image search result using an image search result ranking machine learning model that has been trained to generate a relevance score that measures a relevance of the candidate image search result to the image search query; ranking the candidate image search results based on the relevance scores generated by the image search result ranking machine learning model; generating an image search results presentation that displays the candidate image search results ordered according to the ranking; and providing the image search results for presentation by a user device. Other embodiments of this aspect include corresponding computer systems, apparatus, and computer programs recorded on one or more computer storage devices, each configured to perform the actions of the methods. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

The subject matter described in this specification can be implemented in particular embodiments so as to realize one or more of the following advantages. Ranking image-search query pairs based on relevance scores generated by a machine learning model improves the relevance of the image search results in response to the image search query. Unlike conventional methods to rank resources, the machine learning model receives a single input that includes features of the image search query, landing page and the image identified by a given image search result and predicts the relevance of the image search result to the received query. This allows the machine learning model to give more weight to landing page features or image features in a query-specific manner, improving the quality of the image search results that are returned to the user. In particular, by using the described machine learning model, the described image search engine does not apply the same fixed weighting scheme for landing page features and image features for each received query and instead combines the landing page and image features in a query-dependent manner.

Additionally, a trained machine learning model can easily and optimally adjust the weights assigned to various features based on changes to the initial signal distribution or additional features. Conventionally, significant engineering effort is required to adjust the weights of a traditional manually tuned model based on changes to the initial signal distribution. However, adjusting the weights of a trained machine learning model based on changes to the signal distribution is significantly easier, thus improving the ease of maintenance of the image search engine. Furthermore, if a new feature is added, the manually tuned functions adjusts the function on the new feature independently on an objective, i.e., loss function, while holding existing feature functions constant. Without adjusting the existing feature functions with respect to the new feature, the model becomes less optimal with respect to the final objective. However, a trained machine learning model can automatically adjust feature weights if a new feature is added. The machine learning model can include the new feature and rebalance all its existing weights appropriately to optimize for the final objective. Thus, the accuracy, efficiency and the maintenance of the image search engine can be improved.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A is a block diagram of an example search system. FIG. 1B is a block diagram of an example search system for generating a relevance score from image, landing page and query features.

FIG. 2 is a flow chart of an example process for generating image search results from a user submitted image search query.

FIG. 3 is a flow chart of an example process for training a machine learning model to generate relevance scores of an image-landing page pair for an image search query.

Like reference numbers and designations in the various drawings indicate like elements.

### DETAILED DESCRIPTION

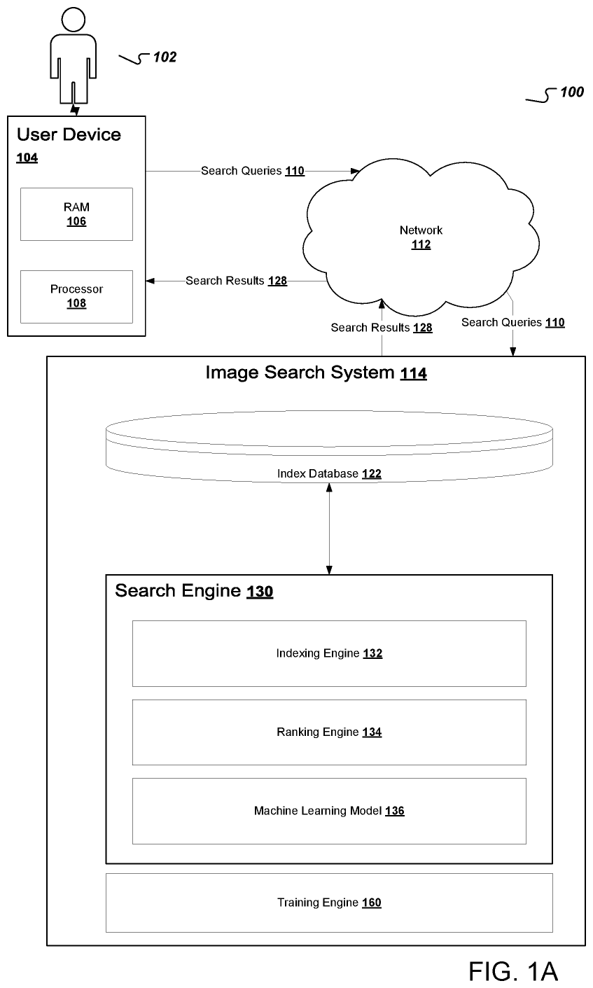

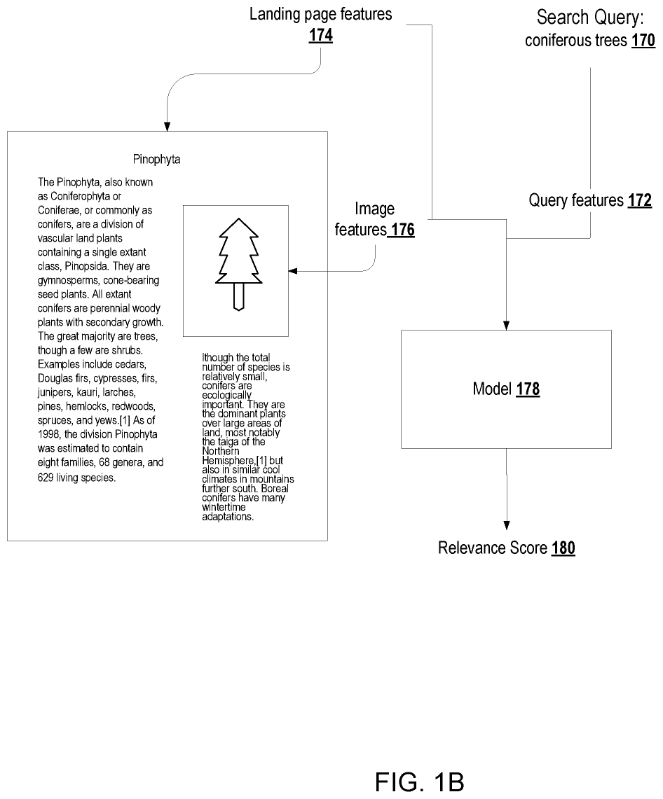

FIG. 1A shows an example image search system 114. The image search system 114 is an example of an information retrieval system in which the systems, components, and techniques described below can be implemented.

A user 102 can interact with the image search system 114 through a user device 104. For example, the user device 104 can be a computer coupled to the image search system 114 through a data communication network 112, e.g., local area network (LAN) or wide area network (WAN), e.g., the Internet, or a combination of networks. In some cases, the image search system 114 can be implemented on the user device 104, for example, if a user installs an application that performs searches on the user device 104. The user device 104 will generally include a memory, e.g., a random access memory (RAM) 106, for storing instructions and data and a processor 108 for executing stored instructions. The memory can include both read only and writable memory.

The image search system 114 is configured to search a collection of images. Generally the images in the collection are images that are found on web pages on the Internet or on a private network, e.g., an Intranet. A web page on which an image is found, i.e., in which an image is included, will be referred to in this specification as a landing page for the image.

The user 102 can submit search queries 110 to the image search system 114 using the user device 104. When the user 102 submits a search query 110, the search query 110 is transmitted through the network 112 to the image search system 114.

When the search query 110 is received by the image search system 114, a search engine 130 within the image search system 114 identifies image—landing page pairs that satisfy the search query 110 and responds to the query 110 by generating search results 128 that each identify a respective image—landing page pair satisfying the search query 110. Each image—landing page pair includes an image and the landing page on which the image is found. For example, the image search result can include a lower-resolution version of the image or a crop from the image and data identifying the landing page, e.g., the resource locator of the landing page, the title of the landing page, or other identifying information. The image search system 114 transmits the search results 128 through the network 112 to the user device 104 for presentation to the user 102, i.e., in a form that can be presented to the user 102.

The search engine 130 may include an indexing engine 132 and a ranking engine 134. The indexing engine 132 indexes image-landing page pairs, and adds the indexed image-landing page pairs to an index database 122. That is, the index database 122 includes data identifying images and, for each image, a corresponding landing page.

The index database 122 also associates the image-landing page pairs with (i) features of the image search query (ii) features of the images, i.e., features that characterize the images, and (iii) features of the landing pages, i.e., features that characterize the landing page. Examples of features of images and landing pages are described in more detail below. Optionally, the index database 122 also associates the indexed image-landing page pairs in the collections of image-landing pairs with values of image search engine ranking signals for the indexed image-landing page pairs. Each image search engine ranking signal is used by the ranking engine 134 in ranking the image-landing page pair in response to a received search query.

The ranking engine 134 generates respective ranking scores for image-landing page pairs indexed in the index database 122 based on the values of image search engine ranking signals for the image-landing page pair, e.g., signals accessed from the index database 122 or computed at query time, and ranks the image-landing page pair based on the respective ranking scores. The ranking score for a given image-landing page pair reflects the relevance of the image-landing page pair to the received search query 110, the quality of the given image-landing page pair, or both.

The image search engine 130 can use a machine learning model 150 to rank image-landing page pairs in response to received search queries.

The machine learning model 150 is a machine learning model that is configured to receive an input that includes (i) features of the image search query (ii) features of an image and (iii) features of the landing page of the image and generate a relevance score that measures a relevance of the candidate image search result to the image search query. Once the machine learning model 150 generates the relevance score for the image-landing page pair, the ranking engine 134 can then use the relevance score to generate ranking scores for the image-landing page pair in response to the received search query.

In some implementations, the ranking engine 134 generates an initial ranking score for each of multiple image—landing page pairs using the signals in the index database 122. The ranking engine 134 can then select a certain number of highest-scoring image—landing pair pairs for processing by the machine learning model 150. The ranking engine 134 can then rank the candidate image—landing page pairs based on the relevance scores generated by the machine learning model 150 or use the relevance scores as additional signals to adjust the initial ranking scores for the candidate image—landing page pairs.

The machine learning model 150 can be any of a variety of kinds of machine learning models. For example, the machine learning model 150 can be a deep machine learning model, e.g., a neural network that includes multiple layers of non-linear operations. As another example, the machine learning model can be a different type of machine learning model, e.g., a generalized linear model, a random forest, a decision tree model, and so on.

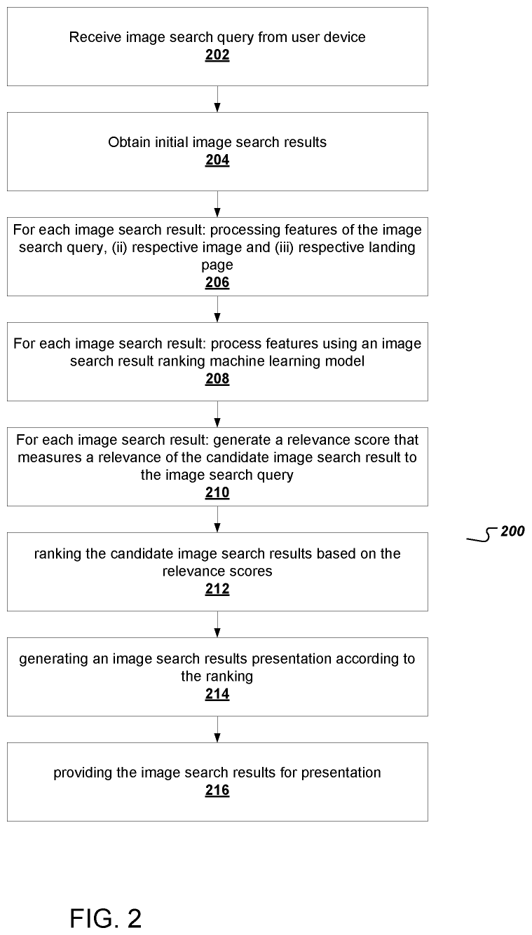

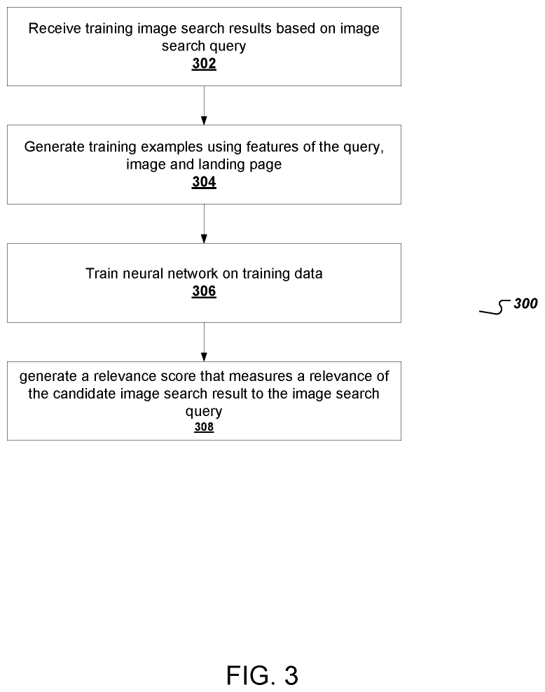

Ranking image—landing page pairs using a machine learning model is described in more detail below with reference to FIGS. 2 and 3.

To train the machine learning model 150 so that the machine learning model 150 can be used to accurately generate relevance scores for image-landing page pairs in the index database 122, the image search system 114 includes a training engine 160. The training engine 160 trains the machine learning model 150 on training data generated using image-landing page pairs that are already associated with ground truth or known values of the relevance score. Training the machine learning model will be described in greater detail below with reference to FIG. 3.

FIG. 1B shows an example of the machine learning model 136 generating a relevance score 180 for a particular image search result from image, landing page and query features.

In the example of FIG. 1B, the user submits an image search query 170. The system generates image query features 172 based on the user submitted image search query 170. Examples of query features 172 are described below with reference to FIG. 2.

The system also generates or obtains landing page features 174 for the landing page identified by the particular image search result and image features 176 for the image identified by the particular image search result. Examples of landing page features 174 and image features 176 are described below with reference to FIG. 2. The system then provides the query feature 172, the landing page feature 174, and the image features 176 as input to the machine learning model 136.

In particular, the machine learning model 136 receives a single input that includes features of the image search query, the landing page, and the image and predicts the relevance, i.e., relevance score 180, of the particular image search result to the user image query 170. This allows the machine learning model to give more weight to landing page features 174, image features 176, or image search query features 172 in a query-specific manner, improving the quality of the image search results that are returned to the user.

FIG. 2 is a flow diagram of an example process for generating image search results from a user submitted image search query. For convenience, the process 200 will be described as being performed by a system of one or more computers located in one or more locations. For example, an image search system, e.g., the image search system 114 of FIG. 1A, appropriately programmed in accordance with this specification, can perform the process 200.

The image search system receives an image search query from a user device (Step 202). In some cases, the image search query is submitted through a dedicated image search interface provided by the image search system, i.e., a user interface for submitting image search queries. In other cases, the search query is submitted through a generic Internet search interface and image search results are displayed in response to the image search query along with other kinds of search results, i.e., search results that identify other types of content available on the Internet.

Upon receiving the image search query, the image search system identifies initial image-landing page pairs (Step 204) that satisfy the image search query. For example, the system can identify the initial image-landing page pairs from the pairs indexed in a search engine index database based on signals that measure the quality of the pairs, the relevance of the pairs to the search query, or both.

For each pair, the system identifies (i) features of the image search query (ii) features of the image and (iii) features of the landing page (Step 206). This can be from the index database or from other data maintained by the system that associates images and landing pages with corresponding features.

For example, the features of the image can include vectors that represent the content of the image. Vectors to represent the image may be derived by processing the image through an embedding neural network. Alternatively, the vectors can be generated through other image processing techniques for feature extraction. Example feature extraction techniques include edge, corner, ridge and blob detection. As another example, the feature vectors can include vectors generated using shape extraction techniques, e.g., thresholding, template matching, and so on. Instead of or in addition to the feature vectors, when the machine learning model is a neural network the features can include the pixel data of the image.

Examples of features extracted from the landing page include the date the page was first crawled or updated, data characterizing the author of the landing page, the language of the landing page, features of the domain that the landing page belong to, keywords representing the content of the landing page, features of the links to the image and landing page such as the anchor text or source page for the links, features that describe the context of the image in the landing page and so on.

Examples of features extracted from the landing page that describe the context of the image in the landing page include data characterizing the location of the image within the landing page, the prominence of the image on the landing page, textual descriptions of the image on the landing page etc. The location of the image within the landing page can be pin-pointed using pixel-based geometric location in horizontal and vertical dimensions, user-device based length (e.g., in inches) in horizontal and vertical dimensions, an HTML/XML DOM-based XPATH-like identifier, a CSS-based selector, etc. The prominence of the image on the landing page can be measured using relative size of the image as displayed on a generic device and on a specific user device. Textual descriptions of the image on the landing page can include alt-text labels for the image, text surrounding the image, and so on.

Examples of features of the image search query may include the language of the search query, some or all of the terms in the search query, the time that the search query was submitted, the location from which the search query was submitted, data characterizing the user device from which the query was received, and so on.

These features may be represented categorically or discretely. Furthermore, additional relevant features can be created through pre-existing features. For example, a system may create relationships between one or more features through a combination of addition, multiplication, or other mathematical operations.

For each image-landing page pair, the system processes the features using an image search result ranking machine learning model to generate a relevance score output (Step 208). The relevance score measures a relevance of the candidate image search result to the image search query. In one example, the relevance score of the candidate image search result measures a likelihood of a user submitting the search query would click on or otherwise interact with the search result. A higher relevance score indicates the user submitting the search query would find the candidate image search more relevant and click on it. In another example, the relevance score of the candidate image search result can be a prediction of a score that would be generated by a human rater to measure the quality of the result for the image search query. Training the machine learning model to generate accurate relevance scores will be described below with reference to FIG. 3.

As described above, the ranking machine learning model may be any of a variety of machine learning models.

The system ranks the image search results based on the relevance scores for the corresponding image search result—landing page pairs (Step 210).

In some implementations, the system ranks the image search results in order based on the relevance scores, i.e., with search results having higher relevance scores being higher in the ranking.

In some other implementations, the system adjusts initial ranking scores for the image search results based on the relevance scores, i.e., to promote search results having higher relevance scores, demote search results having lower relevance scores, or both. For example, the system can determine a modification factor for each search result using the relevance score for the search result. The system can then apply the modification factor to the initial ranking score for the search result, e.g., by adding the modification factor to the initial ranking score or multiplying the initial ranking score by the modification factor, to generate a final ranking score and then rank the initial search results in accordance with the final ranking scores.

The system generates an image search results presentation that shows the image search results according to the ranking (Step 212 and provides the image search result presentation for presentation (Step 214) by sending the search result presentation through a network to the user device from which the image search query was received in a form that can be presented to a user.

FIG. 3 is a flow diagram of an example process 300 for training a ranking machine learning model. For convenience, the process 300 will be described as being performed by a system of one or more computers located in one or more locations. For example, an image search system, e.g., the image search system 114 of FIG. 1A, appropriately programmed in accordance with this specification, can perform the process 300.

The system receives a set of training image search queries, and, for each training image search query, training image search results for the query that are each associated with a ground truth relevance score (Step 302). A ground truth relevance score is the relevance score that should be generated for the image search result by the machine learning model. For example, when the relevance scores measure a likelihood that a user would select a search result in response to a given search query, each ground truth relevance score can identify whether a user submitting the given search query actually selected the image search result or a proportion of times that users submitting the given search query actually select the image search result. As another example, when the relevance scores generated by the model are a prediction of a score that would be assigned to an image search result by a human, the ground truth relevance scores are actual scores assigned to the search results by human raters.

For each of the training image search queries, the system generates features for each associated image-landing page pair (Step 304).

For each pair, the system identifies (i) features of the image search query (ii) features of the image and (iii) features of the landing page. Extracting, generating and selecting features may occur prior to training or using the machine learning model. Examples of features are described above with reference to FIG. 2.

The ranking engine trains the ranking machine learning model by processing for each image search query (i) features of the image search query, (ii) features of the respective image identified by the candidate image search result, and (iii) features of the respective landing page identified by the candidate image search result and the respective ground truth relevance that measures a relevance of the candidate image search result to the image search query (Step 306).

The system trains the machine learning model in a manner that is appropriate for the type of machine learning model that is being used in order to minimize a loss function. For example, if the model is a neural network, the system may train the neural network model to determine trained values of the weights of the neural network from initial values of the weights by repeatedly performing a neural network training procedure to compute a gradient of the loss function with respect to the weights, e.g., using backpropagation, and determining updates to the weights from the gradient, e.g., using the update rule corresponding to the neural network training procedure.

The system can use any of a variety of loss functions in training the machine learning model.

Examples of loss functions that can be used to train the model include pairwise loss, pointwise loss and listwise loss functions.

Pairwise loss functions evaluate two input image search results. Pairwise loss seeks to minimize inversions or incorrect estimations of the ordering of the relevance of the pair compared to the ground truth. That is, when a pairwise loss function is used, the model is trained to generate scores for pairs of search results so the search result with the higher ground truth relevance score is assigned the higher relevance score by the model. At each training step, the system processes features for each image search result in a pair of image search results using the machine learning model to generate a respective predicted relevance score for both search results in the pair. The system then adjusts the weights of the machine learning model to penalize the model when the ordering of the relevance of the pair by predicted relevance score does not match the ordering of the pair by ground truth relevance score.

The pointwise loss function evaluates a single search image result. That is, when a pointwise loss function is used, the model is trained to generate a score for the search result that matches the ground truth score. At each training step, the system processes features for a single image search result using the machine learning model to generate a predicted relevance score for the image search result. The system then adjusts the weights of the machine learning model to penalize the model for deviations between the predicted relevance score and the ground truth relevance score.

The listwise loss function evaluates a list of image search results to find the optimal relevance ranking, i.e., the relevance ranking that matches a ranking of the search results by ground truth relevance scores. That is, at each training step, the system processes features for each search result in a list of search results using the machine learning model to generate a respective predicted relevance score for each search result. The system then adjusts the values of the weights of the model to penalize the model when ranking the search results by predicted relevance score deviates from a ranking of the search results by the ground truth relevance score.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method comprising:
receiving an image search query from a user device;
obtaining a plurality of candidate image search results for the image search query, each candidate image search result identifying a respective image and a respective landing page for the respective image;
for each of the candidate image search results:
processing (i) features of the respective image identified by the candidate image search result, and (ii) features of the respective landing page identified by the candidate image search result using an image search result ranking machine learning model that has been trained to generate a relevance score that measures a relevance of the candidate image search result to the image search query by combining the features of the respective image identified by the candidate image search result and the features of the respective landing page identified by the candidate image search result in a query-dependent manner based on features of the image search query;
ranking the candidate image search results based on the relevance scores generated by the image search result ranking machine learning model;
generating an image search results presentation that displays the candidate image search results ordered according to the ranking; and
providing the image search results for presentation by a user device.

2. The method of claim 1, wherein the candidate image search results are ranked according to an initial ranking, and wherein ranking the candidate image search results based on the relevance scores generated by the image search result ranking machine learning model comprises:
adjusting the initial ranking based on the relevance scores generated by the image search result ranking machine learning model.

3. The method of claim 1, wherein the features of the image search query comprise the text of the image search query.

4. The method of claim 1, wherein the features of the image comprise one or more of pixel data of the image or an embedding of the image.

5. The method of claim 1, wherein the features of the landing page comprise one or more of text from the landing page, a title of the landing page, or a resource locator of the landing page.

6. The method of claim 1, wherein the features of the landing page comprise a feature characterizing a freshness of the landing page.

7. The method of claim 1, wherein the image search result ranking machine learning model is a neural network.

8. The method of claim 1, further comprising:
generating a plurality of training examples; and
training the image search result ranking machine learning model on the training examples.

9. The method of claim 8, wherein each training example comprises a training query, a pair of training image search results, and a label that characterizes a relative relevance of the pair of training image search results to the query, and wherein training the image search result ranking model comprises training the image search result ranking model on the training examples to minimize a pair-wise loss function.

10. The method of claim 8, wherein each training example comprises a training query, a training image search result, and a target relevance score, and wherein training the image search result ranking model comprises training the image search result ranking model on the training examples to generate relevance scores that match the target relevance scores.

11. A system comprising one or more computers and one or more storage devices storing instructions that when executed by the one or more computers cause the one or more computers to perform operations comprising:
receiving an image search query from a user device;
obtaining a plurality of candidate image search results for the image search query, each candidate image search result identifying a respective image and a respective landing page for the respective image;
for each of the candidate image search results:
processing (i) features of the respective image identified by the candidate image search result, and (ii) features of the respective landing page identified by the candidate image search result using an image search result ranking machine learning model that has been trained to generate a relevance score that measures a relevance of the candidate image search result to the image search query by combining the features of the respective image identified by the candidate image search result and the features of the respective landing page identified by the candidate image search result in a query-dependent manner based on features of the image search query;
ranking the candidate image search results based on the relevance scores generated by the image search result ranking machine learning model;
generating an image search results presentation that displays the candidate image search results ordered according to the ranking; and
providing the image search results for presentation by a user device.

12. The system of claim 11, wherein the candidate image search results are ranked according to an initial ranking, and wherein ranking the candidate image search results based on the relevance scores generated by the image search result ranking machine learning model comprises:
adjusting the initial ranking based on the relevance scores generated by the image search result ranking machine learning model.

13. The system of claim 11, wherein the features of the image search query comprise the text of the image search query.

14. The system of claim 11, wherein the features of the image comprise one or more of pixel data of the image or an embedding of the image.

15. The system of claim 11, wherein the features of the landing page comprise one or more of text from the landing page, a title of the landing page, or a resource locator of the landing page.

16. The system of claim 11, wherein the features of the landing page comprise a feature characterizing a freshness of the landing page.

17. The system of claim 11, wherein the image search result ranking machine learning model is a neural network.

18. The system of claim 11, the operations further comprising:
generating a plurality of training examples; and
training the image search result ranking machine learning model on the training examples.

19. The system of claim 18, wherein each training example comprises a training query, a pair of training image search results, and a label that characterizes a relative relevance of the pair of training image search results to the query, and wherein training the image search result ranking model comprises training the image search result ranking model on the training examples to minimize a pair-wise loss function.

20. One or more non-transitory computer-readable storage media storing instructions that when executed by one or more computers cause the one or more computers to perform operations comprising:
receiving an image search query from a user device;
obtaining a plurality of candidate image search results for the image search query, each candidate image search result identifying a respective image and a respective landing page for the respective image;
for each of the candidate image search results:
processing (i) features of the respective image identified by the candidate image search result, and (ii) features of the respective landing page identified by the candidate image search result using an image search result ranking machine learning model that has been trained to generate a relevance score that measures a relevance of the candidate image search result to the image search query by combining the features of the respective image identified by the candidate image search result and the features of the respective landing page identified by the candidate image search result in a query-dependent manner based on features of the image search query;
ranking the candidate image search results based on the relevance scores generated by the image search result ranking machine learning model;
generating an image search results presentation that displays the candidate image search results ordered according to the ranking; and
providing the image search results for presentation by a user device.
